(19) United States
(12) Patent Application Publication
(10) Pub. No.: US 2024/0269865 A1
(43) Pub. Date: Aug. 15, 2024

(54) Compliant Concave Gripper for Robotic Grasping

(71) Applicant: Ghost Robotics Corporation, Philadelphia, PA (US)

(72) Inventors: Avik De, Philadelphia, PA (US); Gavin Kenneally, Philadelphia, PA (US); Thomas Turner Topping, Philadelphia, PA (US)

(21) Appl. No.: 18/439,041

(22) Filed: Feb. 12, 2024

Related U.S. Application Data
(60) Provisional application No. 63/484,517, filed on Feb. 12, 2023.

(51) Int. Cl. B25J 15/00; B25J 15/02

(52) U.S. Cl. CPC B25J 15/0038; B25J 15/0206

(57) ABSTRACT

A gripper designed for grasping objects when mounted on a robotic manipulator is disclosed. The robot gripper may utilize a single actuator to facilitate the grasping of objects of varying shape and size with three degrees of freedom of passive alignment, thus enabling said robot gripper to grasp, push and pull. Passive alignment features assist the robot gripper in executing robust and fast grasping of objects with minimal requirement for active feedback control. The mechanical robot gripper jaw is constructed of a compliant material and a curved rigid member to allow the gripper to cage objects.

### PRIORITY CLAIMS

This application claims the benefit of U.S. Provisional Application Ser. No. 63/484,517 filed Feb. 12, 2023, the contents of which are incorporated herein by reference.

### BACKGROUND OF THE INVENTION

In the field of robotics, attempts to create a robot that emulates the characteristics and abilities of humans and animals alike have posed several challenges. Human and animal motions 10 comprise of deeply complex, intricate movements that are executed by the combination of tendons, muscles, and require substantial dynamic coordination. Further, legged robots and robotic manipulators have immense electromechanical complexity and as a result, reliable execution of ostensibly simple tasks is hindered by shortcomings in hardware and software.

Robotic grasping is a yet-unsolved problem due to the complexity of the contact dynamics that need to be tamed in order to reliably grasp objects of varying size, shape, and weight. For a robotic system to interact with an object in the world, the relative motion of the robot and the object need to be constrained. The role of the gripper, as the sole interfacing element between the robot and the environment, is crucial in the establishment of a grasp. To constrain the relative motion between the gripper and the object, the gripper must surround or “cage” the object, or otherwise be able to apply forces to nullify undesired relative motion between the object and itself. The shape and compliance properties of the gripper play an important role in the magnitudes and directions of the forces between the gripper and object.

Precise software control of these interactions is challenging due to the speed at which contacts can be made or broken in gripper-object interactions. Typically, the control bandwidth with any form of software control may not be high enough to compensate for unexpected contact or loss of contact. Therefore, hardware solutions for stabilizing the contact are beneficial.

There exists a need for a more streamlined design process to execute the grasping control; specifically, one that considers a myriad of factors such as system complexity, system responses to unexpected contact and large areas of contact, and cost without compromising elegance, efficiency, and practicality. Accordingly, an approach that implements a mechanical solution to passively stabilize the contact by way of a specialized gripper design is desirable.

The use of a single actuator to control the open and closed grasp of a standalone or attachable robot clasp or “jaw” abbreviates the construction process and reduces system complexity and cost. A need is evident in the relevant art for a gripper without an overly complex design and the ability to adapt to various types of objects and grasps, while minimizing the number of actuators needed, without sacrificing organic or uncontrived motion.

### SUMMARY OF INVENTION

Considering the motivation outlined above, a gripper for robotic grasping with low complexity and mechanical properties that passively minimize alignment errors is advantageous for robots. Traditional robots include actuators such as, by way of example and not limitation, electric motors, and hydraulic and pneumatic actuators. Robots can retrieve data using sensors such as position, force, proximity, vision, and tactile sensors. Power sources, transmissions, computing, and cooling systems are standard elements in the field of robotics and may be employed in the present invention. Other features such as cables to transmit electrical signals and a control apparatus may also be present.

In the present invention, the platform of interest is a robotic manipulator with a gripper, or gripper jaws, which may stand alone or be attached to a mobile robot. The term gripper jaw may also be used throughout and pertain to the concaved upper and lower arms or opposing members forming the jaws of the present invention. The gripper enables the robot to execute grasping tasks in order to control interactions with objects in the world. A mechanism to drive one or more gripper jaws, such as an electric motor, and a transmission such as a worm gear, is utilized.

The concave gripper facilitates three degrees of freedom of passive alignment between the gripper and the grasped object by the nature of its shape, to enable robust and fast gasping of objects. This alignment is vital for establishing grasps rapidly with minimal active feedback control implemented in software. The present invention's use of a single actuator to open and close the gripper and its lowered reliance on high bandwidth control to stabilize grasping, reduce system complexity and cost. In various embodiments, the concave gripper can grasp a variety of objects, by way of example and not limitation, bottles, doorknobs, handles, small boxes, tennis balls and similarly sized balls used in sports, as well as other standard handheld objects.

Each jaw may be able to move in a plane via a combination of rotational and translation motion when actuated. In one embodiment, the gripper jaw rotates about a pivot point to open and close when actuated by the actuator. In another embodiment, the jaw is driven by the actuator via a four-bar linkage which causes the jaw to only translate when the actuator moves the jaw (creating a set of parallel jaws). In a third embodiment, a single jaw is driven directly or via a transmission such as a gearbox, linkage, or worm gear.

The present invention is also robust to unexpected or early contact due to the large surface area of contact and the compliance properties of the gripper. Embodiments support a reinforced jaw constructed of compliant material to allow the gripper to deform and conform as it is pushed into objects. The rigid element can have a curved shape to allow the gripper to fully cage objects such as a thin rod for pulling, if desired. The compliant element is designed to have a curved and expanding (proximal to distal) “duck-bill” shape for passive alignment in lateral directions during grasping and for pushing. In some embodiments, the surface of the compliant element features a series of nubs using non-slip, adhesive, frictional, or tractional materials to enhance stability when grasping textured objects.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The various embodiments are illustrated by way of example, and not by way of limitation, in the figures of the accompanying drawings. Having thus described the invention in general terms, reference will now be made to the accompanying drawings, which are not necessarily drawn to scale, and wherein:

FIG. 1A depicts an exemplary gripper with compliant and rigid members with right, front, and perspective views.

FIG. 1B depicts an exemplary gripper with compliant and rigid members with left, right, and rear facing views.

FIG. 2 depicts the gripper demonstrating passive alignment from left to right on a doorknob, door exit bar, tennis ball, and cylinder.

FIG. 3 shows an exemplary gripper with a series of nubs.

FIG. 4 depicts an embodiment of the gripper.

FIG. 5 depicts existing types of robotic grippers for grasping various shapes and objects.

### DETAILED DESCRIPTION OF THE DRAWINGS

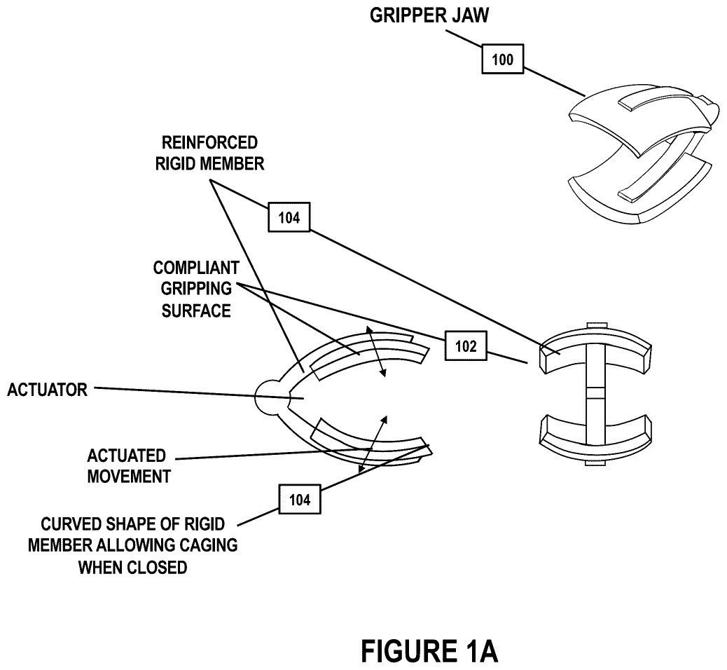

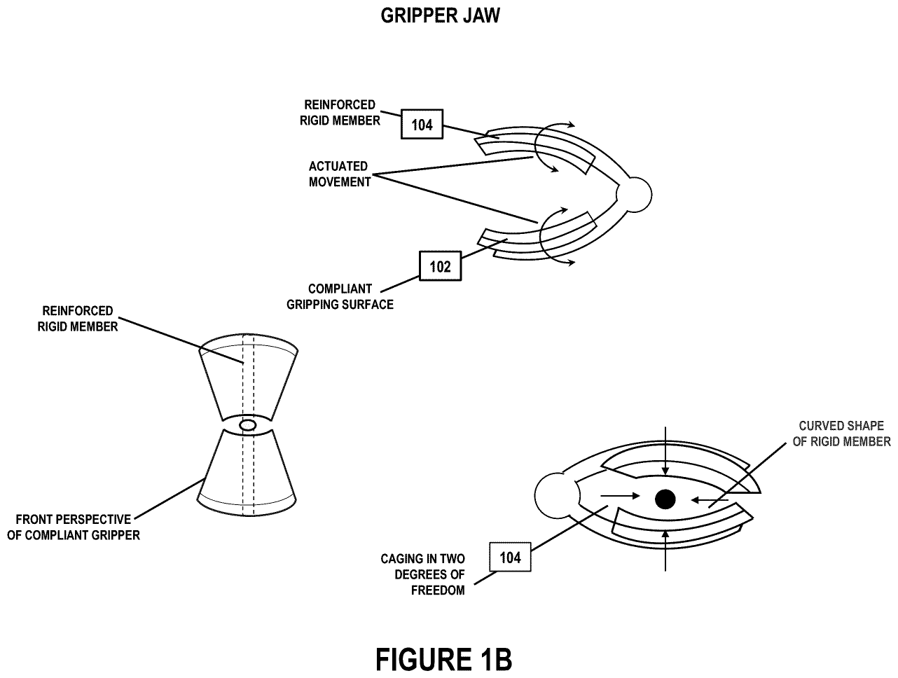

FIG. 1A and 1B depict a gripper 100 according to an aspect of the invention of the present disclosure. Gripper 100 may include upper and lower jaws. One or more of the upper and lower jaws may include one or more of a compliant member 102 and a rigid member 104. The shape and construction of the gripper 100 may allow passive alignment in the vertical direction when pushing.

Rigid member 104 may have a curved shape for caging upon closure of the gripper 100. One or both rigid members 104 may be connected at one end to an actuator to open and/or close the jaws of the gripper 100. In one aspect, rigid member 104 may be formed of aluminum.

Compliant member 102 may be coupled to rigid member 104 and may have a curved and expanding (proximal to distal) shape. In one aspect, complaint member 102 may be concave and shaped in a portion of a sphere. In one aspect, compliant member 102 may be formed of silicone.

The actuator 106 assists with actuated movement, represented by arrows in FIG. 1. The curved shape of the compliant elements 102 allow for passive alignment in the other two degrees of freedom.

In one aspect, jaws can be actuated independently with an actuator connected to the jaw either directly (direct drive), via a linkage, or via a gearing mechanism. Alternatively, the upper and lower jaws can be driven in tandem with one actuator using a linkage or gear mechanism to connect jaws to one actuator. In another aspect, one jaw may remain fixed, while the other jaw is actuated by an actuator (direct drive, or via linkage or gearing) .

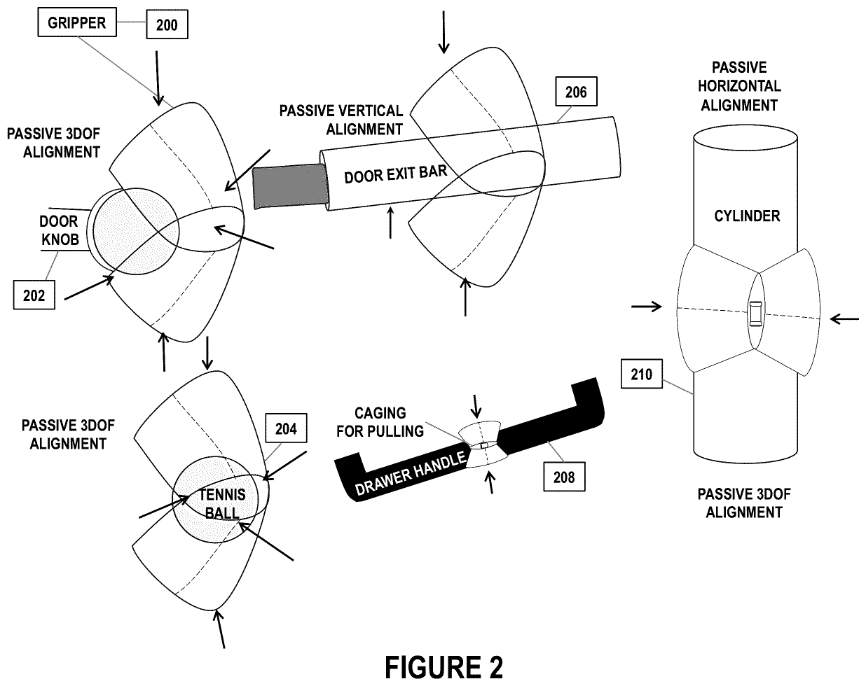

FIG. 2 depicts passive alignment demonstrated in various applications. Various forms of grasping are possible with the design of the present invention. The figure depicts the gripper 200 demonstrating passive alignment from left to right on a doorknob 202, tennis ball 204 and cylinder 210. Passive vertical alignment is demonstrated by way of a door exit bar 206. For example, passive unidirectional alignment when pushing due to the shape of the jaws and passive three degrees of freedom alignment when pushing on a spherical or circular object such as a doorknob 202 or tennis ball 204. Another includes passive unidirectional alignment when the gripper is closed, and usage of the caging regions to pull an object, typically with handles, such as a drawer handle 208. The jaw axis, as defined herein, is the axis outward along the jaw, with the most proximal point being near the actuator and the most distal point being the distal end of the aforementioned rigid and compliant members. The lateral axis is defined as being parallel to the axis along which the jaw actuator acts. The shape of the compliant portion of the gripper jaw can be described as having a concave curvature in the lateral axis. The radius of curvature increases slightly as we move outward along the jaw axis. In the jaw axis, the shape could have either no curvature, or a slightly concave curvature. The width of the compliant element increases as we move outward along the jaw.

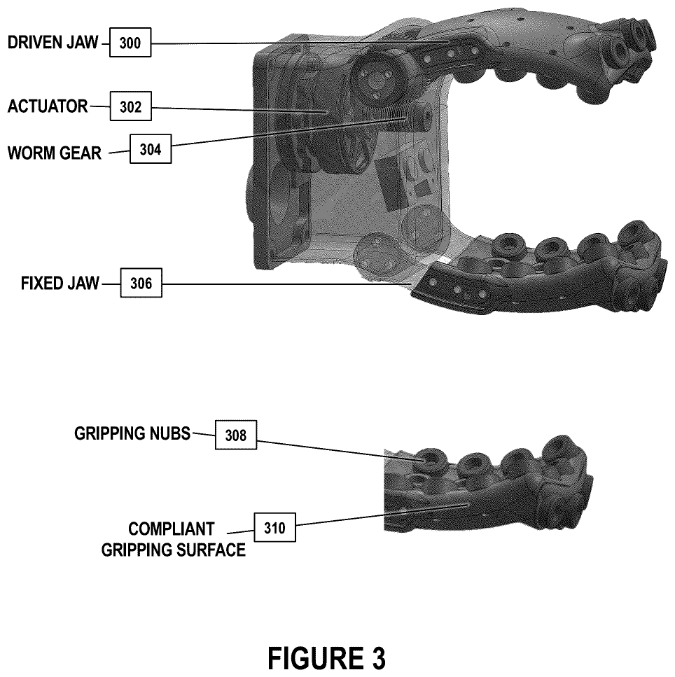

FIG. 3 shows an exemplary gripper with gripping nubs 308. The gripping nubs 308 may be textured in a variety of ways so that it may hold and grasp on to objects of different textures and sizes. Gripping nubs 308 may be made from non-slip, adhesive, frictional or tractional materials to create a compliant gripping surface 310 and enhance stability when gripping. The materials may coat the nubs or manifest as different ‘caps’ for the nubs, which enable modifications depending on the texture of the object. In one aspect, the gripper may include a driven jaw 300, an actuator 302, worm gear 304, and a fixed jaw 306. The gripping nubs 308 may be arranged in rows on the interior of the jaw and/or as a raised portion on the front face of the jaw. It may also include, in some embodiments, a limited number of grippers for specific gripping operations. Ultimately, the assortment of grippers can be modified according to the operation.

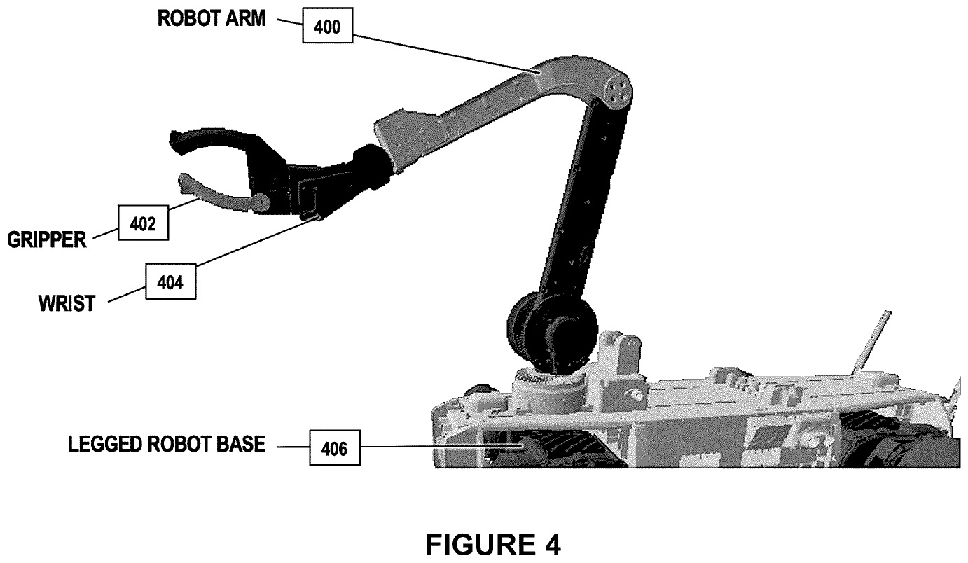

FIG. 4 depicts an embodiment of the gripper mounted on a robot base. The gripper 402 is in reference to the ‘hand’ of the robot, or the appendage that grasps and clasps on to objects. In this embodiment, the gripper is mounted on a legged robot base 406 with an extending robot arm 400 and features a mechanical wrist 404. A lone actuator may be used to control the compliant gripper to avoid affecting the operations of the other elements of the robot.

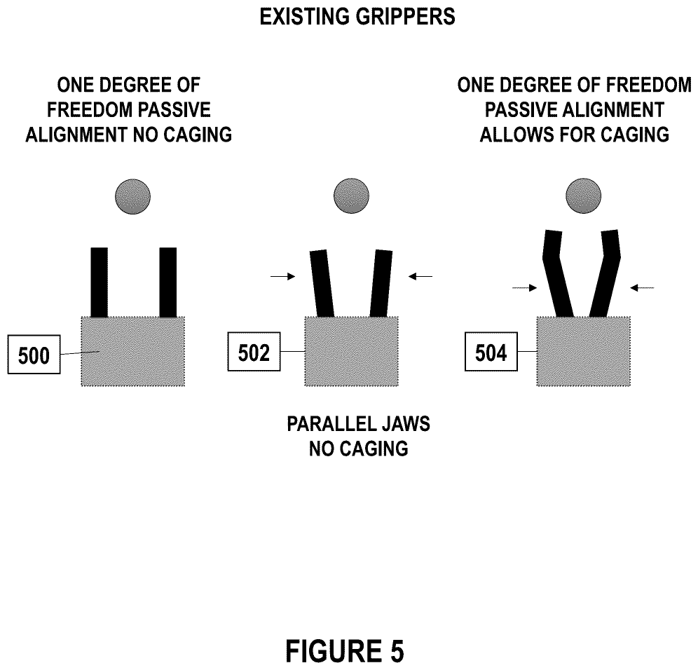

FIG. 5 depicts three embodiments of a two-fingered gripper that are found in related art, but none of them exhibit all the features of the present invention. Jaw 500 has no caging, jaw 502 has one degree of freedom passive alignment and no caging. Jaw 504 has one degree of freedom with passive alignment and allows for caging when the jaws are shut, which allows the jaws to grasp on an object and “cage” it without enabling the release of said object. The design in 504 does not exhibit passive alignment out of the plane of the paper, whereas the disclosed gripper 100 of the present disclosure exhibits three degrees of freedom of passive alignment as shown in FIG. 2.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical, or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future. What is claimed is:

1. A robot comprising:
an actuator for actuating a prehension operation of a robotic manipulator, and wherein said robotic manipulator is an end-effector;
a concave gripper on a jaw of said end-effector, and wherein said concave gripper enables at least three directions of movement including movement in vertical and horizontal directions and a push and pull direction by way of said actuator; and
a rigid member on said concave gripper to allow said concave gripper to cage around an object while executing said prehension operation.

2. The robot of claim 1, further comprising: a plurality of gripping nubs disposed along said concave gripper to maintain stability when said end-effector is gripping an object.

3. The robot of claim 1, wherein said concave gripper has a curved and expanding proximal to distal shape.

4. The robot of claim 3, wherein said curved and expanding proximal to distal shape of said concave gripper enables passive alignment in lateral directions.

5. The robot of claim 1, wherein said jaw comprises a compliant shaping material to enable said concave gripper to be closed and caged around a loop for pulling and allows said concave gripper to deform and conform to tangible objects as it is pushed into tangible objects.

6. The robot of claim 1, wherein one of said at least three directions of movement include passive unidirectional alignment when pushing.

7. The robot of claim 1, wherein said concave gripper comprises one or more of a non-slip, adhesive, frictional and tractional material for a compliant gripping surface.

8. A method for robotic operation, comprising:
actuating a prehension operation of a robotic manipulator using an actuator, wherein said robotic manipulator is an end-effector;
enabling a concave gripper on a jaw of said end-effector to effectuate at least three directions of movement, including movement in vertical and horizontal directions and a push and pull direction by way of said actuator; and
using a rigid member on said concave gripper to allow said concave gripper to cage around an object while executing said prehension operation.

9. The robot of claim 8, wherein a plurality of gripping nubs disposed along said concave gripper to maintain stability when said end-effector is gripping an object.

10. The robot of claim 8, wherein said concave gripper has a curved and expanding proximal to distal shape.

11. The robot of claim 10, wherein said curved and expanding proximal to distal shape of said concave gripper enables passive alignment in lateral directions.

12. The robot of claim 8, wherein said jaw comprises a compliant shaping material to enable said concave gripper to be closed and caged around a loop for pulling and allows said concave gripper to deform and conform to objects as it is pushed into objects.

13. The robot of claim 8, wherein one of said at least three directions of movement include passive unidirectional alignment when pushing.

14. The robot of claim 8, wherein said concave gripper comprises one or more of a non-slip, adhesive, frictional, and tractional material for a compliant gripping surface.

15. A robot comprising:
an end-effector comprising a first jaw member opposing a second jaw member;
the first jaw member comprising a first member extending in a longitudinal direction and being substantially arc-shaped in the longitudinal direction;
the first jaw member further comprising a second member extending in the longitudinal direction of the first member and being substantially arc-shaped in the longitudinal direction and further extending laterally forming a substantially concave shape;
the second jaw member having a concave shape opposing and substantially similar to the first jaw member;
a motor mechanically coupled to and capable of moving at least one of the first jaw member and the second jaw member;
a material coating the first and second jaw members to provide stability when said gripper jaw executes a prehension operation.

16. The robot of claim 15, wherein the first jaw member comprises a plurality of nubs made with non-slip material disposed on a portion of the first jaw member facing the second jaw member.

17. The robot of claim 15, wherein the end-effector forms a caging mechanism during prehension operation.

18. The robot of claim 15, wherein the end-effector is mounted on a legged robot.

19. The robot of claim 15, wherein the gripper jaw is a three-point gripper.

20. The robot of claim 15, wherein the end-effector has a sensor.
